(19) United States
(12) Patent Application Publication
(10) Pub. No.: US 2020/0310316 A1
(43) Pub. Date: Oct. 1, 2020

(54) IMAGE FORMING APPARATUS

(71) Applicant: FUJI XEROX CO., LTD., Tokyo (JP)

(72) Inventors: Ryota TOMISHI, Kanagawa (JP); Masanori KATO, Kanagawa (JP); Yoshifumi OZAKI, Kanagawa (JP)

(73) Assignee: FUJI XEROX CO., LTD., Tokyo (JP)

(21) Appl. No.: 16/589,491

(22) Filed: Oct. 1, 2019

(30) Foreign Application Priority Data
Apr. 1, 2019 (JP) 2019-069784

(51) Int. Cl. G03G 15/00; G03G 15/16

(52) U.S. Cl. CPC G03G 15/5037; G03G 15/5041; G03G 15/5004; G03G 15/163

(57) ABSTRACT

An image forming apparatus includes: an image carrier in which a latent image is formed; a developing device that transfers toner to the latent image from a developing member opposed to the image carrier, and develops the latent image; a development power supply that applies a development voltage across the image carrier and the developing member; a period detector that detects periodic information on the developing member and the image carrier in a circumferential direction; and a corrector that corrects the development voltage or an exposure amount of the latent image based on the periodic information detected by the period detector. At least one of the developing device and the development power supply is set so that a supply rate of charge of the toner to the latent image in a solid area of an image reaches 80% or higher.

### CROSS-REFERENCE TO RELATED APPLICATIONS

This application is based on and claims priority under 35 USC 119 from Japanese Patent Application No. 2019-069784 filed Apr. 1, 2019.

### BACKGROUND

### (i) Technical Field

The present disclosure relates to an image forming apparatus.

### (ii) Related Art

Japanese Unexamined Patent Application Publication No. 2015-004875 discloses an image forming apparatus that detects information on periodic variation which occurs with an oscillation period of a developing sleeve, and corrects development bias, thereby adjusting the image quality.

### SUMMARY

In a conventional image forming apparatus, due to oscillation and eccentricity of a roller-shaped developing member and an image carrier such as a photoreceptor, the gap (hereinafter may be referred to as “DRS”) between the developing member and the image carrier changes periodically, and periodic concentration unevenness (so-called banding) occurs at positions where the gap is large or small.

To cope with the periodic concentration unevenness, a period of the gap between the developing member and the image carrier is detected, for instance, and a development amount is corrected by adjusting an exposure amount (in other words, the potential difference between the developing member and the image carrier) based on the period.

However, in the periodic concentration unevenness (so-called banding), the concentration difference between a high concentration area and a low concentration area varies depending on an area coverage. The higher the area coverage, the greater the concentration difference is. For this reason, when a correction amount is controlled with an exposure amount which is constant in the axial direction of the image carrier, the effectiveness of concentration correction is different for each area coverage because the concentration difference varies depending on the area coverage. It is to be noted that the area coverage refers to the value (%) indicating the amount of toner used per unit area for an image formed on a photoreceptor.

Aspects of non-limiting embodiments of the present disclosure relate to provide an image forming apparatus that reduces the image concentration unevenness which occurs in the axial direction of the image carrier, as compared with when the supply rate of the charge of toner to a latent image in a solid area of an image is lower than 80%.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: an image carrier in which a latent image is formed; a developing device that transfers toner to the latent image from a developing member opposed to the image carrier, and develops the latent image; a development power supply that applies a development voltage across the image carrier and the developing member; a period detector that detects periodic information on the developing member and the image carrier in a circumferential direction; and a corrector that corrects the development voltage or an exposure amount of the latent image based on the periodic information detected by the period detector. At least one of the developing device and the development power supply is set so that a supply rate of charge of the toner to the latent image in a solid area of an image reaches 80% or higher.

### BRIEF DESCRIPTION OF THE DRAWINGS

Exemplary embodiment of the present disclosure will be described in detail based on the following figures, wherein:

FIG. 1 is a schematic configuration view illustrating an example of an image forming apparatus according to an exemplary embodiment;

FIG. 2 is a configuration view illustrating a single color unit of the image forming apparatus according to the exemplary embodiment;

FIG. 3 is a block diagram illustrating the hardware configuration of a control system;

FIG. 4 is an illustration showing an example of periodic concentration unevenness of an image formed on a recording medium;

FIG. 5 is an illustration showing an example of a solid image and an image with a low area coverage formed on a recording medium;

FIG. 6 is a graph illustrating the relationship between the gap difference across a photoreceptor and a developing roller, and the concentration difference between a high concentration area and a low concentration area according to a high area coverage and a low area coverage;

FIG. 7A is a graph illustrating the concentration difference between a high concentration area and a low concentration area according to a high area coverage and a low area coverage, and FIG. 7B is a graph illustrating the concentration difference after correction between the high concentration area and the low concentration area according to a high area coverage and a low area coverage;

FIG. 8 is a graph illustrating the relationship between the potential difference across the photoreceptor and the developing roller, and the concentration (D) of an image;

FIG. 9A is a schematic image illustrating the state of the photoreceptor and the developing roller before development, and FIG. 9B is a schematic image illustrating a development process caused by the potential difference between the photoreceptor and the developing roller;

FIG. 10A is a schematic image illustrating a development state caused by the potential difference between the photoreceptor in a solid area and the developing roller, and FIG. 10B is a schematic image illustrating a development state caused by the potential difference between the photoreceptor with a low area coverage and the developing roller;

FIG. 11A is a schematic image illustrating a development state when the supply rate of toner achieved by the potential difference between the photoreceptor in a solid area and the developing roller is low, and FIG. 11B is a schematic image illustrating a development state when the supply rate of toner achieved by the potential difference between the photoreceptor with a low area coverage and the developing roller is low;

FIG. 12 is a graph illustrating the relationship between the variation amount in the gap across the photoreceptor and the developing roller according to a difference in the area coverage, and a necessary correction amount to the potential difference between the photoreceptor and the developing roller when the supply rate of toner to a latent image is low;

FIG. 13 is a graph illustrating the relationship between the variation amount in the gap across the photoreceptor and the developing roller according to a difference in the area coverage, and a necessary correction amount to the potential difference between the photoreceptor and the developing roller when the supply rate of toner to a latent image is high;

FIG. 14 is a graph illustrating the concentration difference between a high concentration area and a low concentration area according to a difference in the area coverage in an image forming apparatus of a comparative example and the image forming apparatus in the exemplary embodiment;

FIG. 15 is a graph illustrating a correction amount to the concentration difference between a high concentration area and a low concentration area according to a difference in the area coverage in the image forming apparatus of the comparative example and the image forming apparatus in the exemplary embodiment;

FIG. 16 is a graph illustrating the concentration difference after correction between a high concentration area and a low concentration area according to a difference in the area coverage in the image forming apparatus of the comparative example and the image forming apparatus in the exemplary embodiment;

FIG. 17A is a graph illustrating the concentration difference between a high concentration area and a low concentration area according to a high area coverage and a low area coverage, and FIG. 17B is a graph illustrating the concentration difference between a high concentration area and a low concentration area according to a difference in the area coverage made by increasing the supply rate of toner to a latent image;

FIG. 18 is a graph illustrating the concentration difference between a high concentration area and a low concentration area according to a high area and coverage a low area coverage when the supply rate of toner to a latent image in a solid area of an image is 100%;

FIG. 19 is a view illustrating an example of an image former for measuring the supply rate of toner to a latent image;

FIG. 20 is a table illustrating the value obtained by subtracting the concentration difference between a high concentration area and a low concentration area from the gap between the photoreceptor and the developing roller when the supply rate of toner to a latent image and the area coverage are changed;

FIG. 21 is a table illustrating evaluation of image quality when the supply rate of toner to a latent image and the area coverage are changed;

FIG. 22 is a graph illustrating the relationship between the amplitude value Vpp of AC voltage of a development voltage and the supply rate of toner charge; and

FIG. 23 is a graph illustrating the relationship between the circumferential speed ratio of the developing roller to the photoreceptor and the supply rate of toner charge.

### DETAILED DESCRIPTION

Hereinafter, an embodiment (hereinafter referred to as an exemplary embodiment) for carrying out the present disclosure will be described. In the following description, the direction indicated by an arrow symbol X in the drawings is referred to as the apparatus width direction, and the direction indicated by an arrow symbol Y in the drawings is referred to as the apparatus height direction. The direction (arrow symbol Z direction) perpendicular to each of the apparatus width direction and the apparatus height direction is referred to as the apparatus depth direction.

### First Exemplary Embodiment

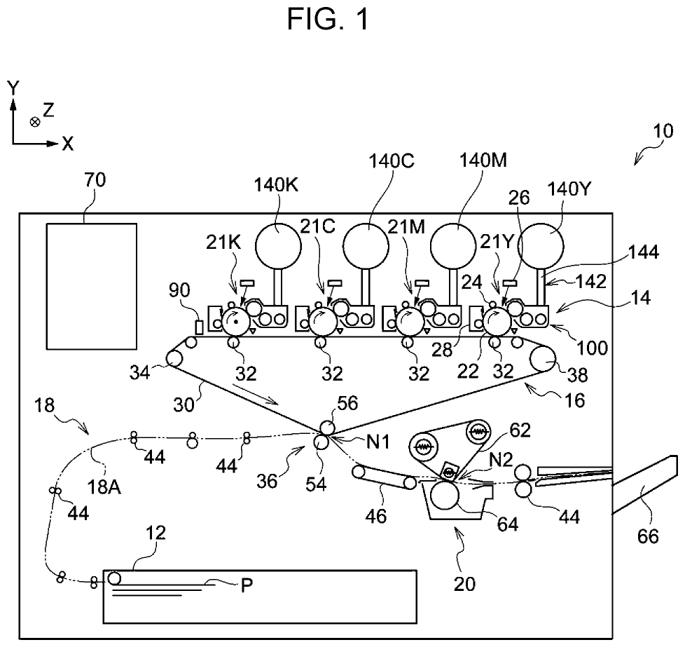

An image forming apparatus according to a first exemplary embodiment will be described with reference to FIGS. 1 to 22.

FIG. 1 illustrates an example of an image forming apparatus 10 in the exemplary embodiment. First, the overall configuration of the image forming apparatus 10 in the exemplary embodiment will be described. Next, a developing device 100 will be described.

### <Overall Configuration of Image Forming Apparatus>

As illustrated in FIG. 1, the image forming apparatus 10 is an apparatus based on the electrophotographic system, including a recording medium storage 12, a toner image former 14, a transfer device 16, a recording medium transport device 18, a fixing device 20, and a control device 70.

The recording medium storage 12 has a function of storing paper P as a recording medium before an image is formed.

The toner image former 14 has a function of forming a toner image carried by the later-described intermediate transfer belt configurated by the transfer device 16 by performing the steps of charging, exposing, and developing. As an example, the toner image former 14 includes single-color units 21Y, 21M, 21C, and 21K that form a toner image on each of photoreceptors 22 using toner of different colors (Y(yellow), M(magenta), C(cyan), K(black)). The toner image former 14 is capable of forming a toner image composed of multiple colors according to image data, for instance. The photoreceptors 22 are each an example of an image carrier.

The single-color units 21Y, 21M, 21C, and 21K have the same structure except for the color of a toner image formed by each single-color unit. Hereinafter when the single-color units 21Y, 21M, 21C, and 21K and their components do not need to be distinguished, a description will be given by omitting the alphabets (Y, M, C, and K) of the single-color units 21Y, 21M, 21C, and 21K. Each single-color unit 21 includes a photoreceptor 22, a charging device 24, an exposing device 26, a developing device 100, and a cleaning device 28.

The transfer device 16 has functions of carrying a toner image of each color formed by each single-color unit 21 and transferring the toner image onto transported paper P. The transfer device 16 includes an intermediate transfer belt 30, four transfer rollers 32, a drive roller 38, a secondary transfer unit 36, and a tension roller 34. The intermediate transfer belt 30 is in an endless shape. The four transfer rollers 32 each form a nip by sandwiching the intermediate transfer belt 30 with a photoreceptor 22. The intermediate transfer belt 30 is circumferentially moved by the drive roller 38 in the arrow symbol direction. In the exemplary embodiment, as an example, the single-color units 21Y, 21M, 21C, and 21K are disposed in that order from the upstream side toward the downstream side in the circumferential movement direction of the intermediate transfer belt 30. Thus, a toner image on each photoreceptor 22 formed by the single-color units 21Y, 21M, 21C, and 21K is overlaid on the intermediate transfer belt 30 and is transferred by the transfer roller 32.

On the downstream side of the single-color units 21Y, 21M, 21C, and 21K in the circumferential movement direction of the intermediate transfer belt 30 and on the upstream side of the secondary transfer unit 36, a period sensor 90 is provided which detects periodic information on the photoreceptors 22 and the later-described developing rollers 106 in the circumferential direction. The period sensor 90 is an example of a period detector. In the image forming apparatus 10, the gap (that is DRS) between each developing roller 106 and a corresponding photoreceptor 22 may change periodically due to oscillation and eccentricity of the developing roller 106 and the photoreceptor 22. When the gap between the developing roller 106 and the photoreceptor 22 changes periodically, the concentration of a toner image transferred onto the intermediate transfer belt 30 is likely to change periodically in the circumferential direction. In other words, there is a correlation between the concentration of a toner image on the intermediate transfer belt 30 and the gap between the developing roller 106 and the photoreceptor 22. In the exemplary embodiment, the period sensor 90 detects periodic information on the photoreceptor 22 and the developing roller 106 in the circumferential direction by detecting the concentration of a toner image transferred onto the intermediate transfer belt 30. The period sensor 90 detects periodic information, for instance, for each of the single-color units 21Y, 21M, 21C, and 21K.

The secondary transfer unit 36 includes a transfer roller 54 in contact with a surface which holds a toner image of the intermediate transfer belt 30, and an opposite roller 56 disposed to be opposed to the transfer roller 54 with the intermediate transfer belt 30 interposed therebetween. The secondary transfer unit 36 is designed to transfer a toner image of each color carried by the intermediate transfer belt 30 onto the transported paper P.

The recording medium transport device 18 has a function of transporting the paper P so that the paper P passes through a nip N1 of the secondary transfer unit 36 and a nip N2 of the fixing device 20. The recording medium transport device 18 includes multiple transport rollers 44, and a transport belt 46. The transport rollers 44 are formed by a pair of rollers which are disposed in a contact state. The transport rollers 44 are designed to transport the paper P stored in the recording medium storage 12 along a transport path 18A.

The transport belt 46 has a configuration in which an endless belt is wounded on a pair of rollers separately disposed. The transport belt 46 is disposed on the downstream side of the secondary transfer unit 36 and on the upstream side of the fixing device 20 in the transport direction of the paper P. The transport belt 46 is designed to transport the paper P, onto which a toner image has been transferred by the secondary transfer unit 36, to the fixing device 20 along the transport path 18A.

The fixing device 20 has a function of fixing a toner image at the nip N2, the toner image being transferred (secondarily transferred) onto the paper P by the transfer device 16. The fixing device 20 includes a heater 62 in which an endless belt is circumferentially moved, and a pressure roller 64 which comes into pressure contact with the heater 62. The paper P is transported to the nip N2 between the heater 62 and the pressure roller 64, and thus a toner image of the paper P is fixed by heating and pressure.

The control device 70 has a function of controlling each component of the image forming apparatus 10. For instance, the control device 70 is designed to control each component (to cause each component to perform a corresponding operation) of the image forming apparatus 10 according to job data received from an external device (not illustrated). The job data includes image data (image information) for causing each single-color unit 21 to form a toner image, and necessary data for other image forming operations.

The image forming apparatus 10 includes multiple toner cartridges 140Y, 140M, 140C, and 140K that store toner of different colors (Y(yellow), M(magenta), C(cyan), K(black)). In addition, the image forming apparatus 10 includes toner transport devices 142 that transport toner T of each color from the toner cartridges 140Y, 140M, 140C, and 140K to the developing devices of the single-color units 21Y, 21M, 21C, and 21K. The toner transport devices 142 include transport paths 144 that connect the toner cartridges 140Y, 140M, 140C, 140K and the developing devices 100 of each color, and transport members (not illustrated) that are disposed inside the transport paths 144 and transport the toner T of each color.

### <Operation of Image Forming Apparatus>

Next, the operation of the image forming apparatus 10 will be described.

The control device 70 which has received job data from an external device (not illustrated) causes the toner image former 14, the transfer device 16, the recording medium transport device 18, and the fixing device 20 to operate. In the toner image former 14, each photoreceptor 22 is charged by a corresponding charging device 24, the photoreceptor 22 is exposed to light by a corresponding exposing device 26, and a latent image (that is an electrostatic latent image) is thereby formed, then the latent image of each photoreceptor 22 is developed as a toner image by a corresponding developing device 100. Consequently, a toner image is formed on each photoreceptor 22.

Next, a voltage (a first transfer voltage) is applied to each transfer roller 32 from a power supply (not illustrated). The drive roller 38 driven by a drive source (not illustrated) causes the intermediate transfer belt 30 to circumferentially move in the arrow symbol direction. Consequently, a toner image of each color is overlaid and firstly transferred onto the intermediate transfer belt 30.

In addition, the recording medium transport device 18 delivers the paper P to the nip N1 at the timing when a toner image of each color carried by the circumferentially moving intermediate transfer belt 30 reaches the nip N1. In the secondary transfer unit 36, a voltage (a secondary transfer voltage) is applied from a power supply (not illustrated) to a power supply roller (not illustrated) in contact with the outer circumference of the opposite roller 56, and a toner image of each color is thereby secondarily transferred onto the paper P which passes through the nip N1.

Next, the recording medium transport device 18 delivers the paper P, onto which a toner image of each color has been secondarily transferred, to the nip N2. Consequently, a toner image of each color is fixed by the fixing device 20 onto the paper P which passes through the nip N2, and an image is thereby formed on the paper P. Subsequently, the paper P is ejected to an ejection unit 66 by the transport roller 44.

### <Developing Device>

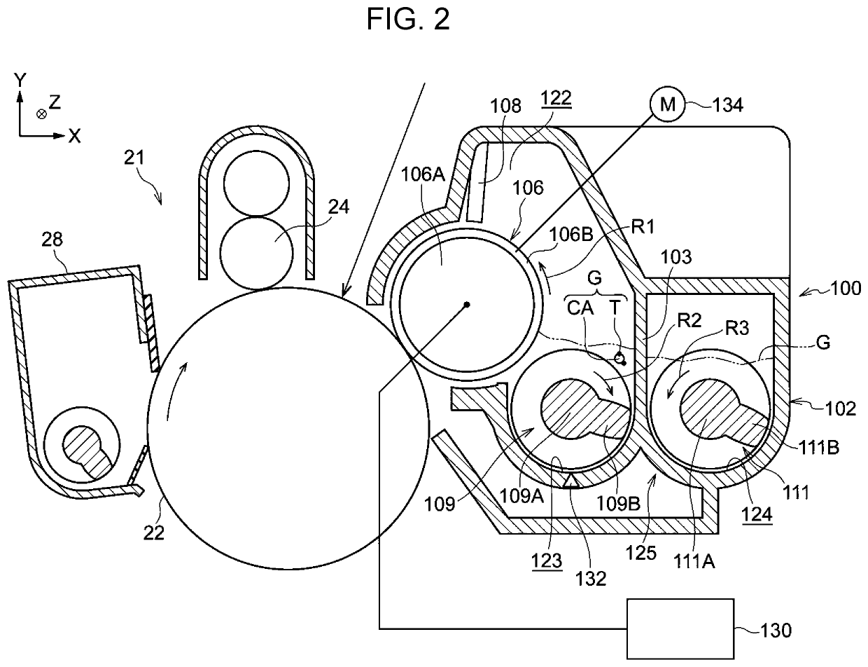

Next, the developing device 100 will be described. As illustrated in FIG. 2, the developing device 100 has a housing 102 that houses developer G, a developing roller 106 that holds the developer G, a layer thickness regulating member 108 that regulates the thickness of the layer of the developer G on the outer circumference surface of the developing roller 106, and a developer agitating transporter 125. The developer agitating transporter 125 has a first agitation transport chamber 123, and a second agitation transport chamber 124 adjacent to the first agitation transport chamber 123. In addition, the first agitation transport chamber 123 is provided with a first auger 109, and the second agitation transport chamber 124 is provided with a second auger 111.

As illustrated in FIG. 2, as an example, the developer G is composed of two-component developer including non-magnetic toner T which is charged with a negative polarity, and magnetic carrier CA which is charged with a positive polarity.

The housing 102 has a developing roller chamber 122 that stores the developing roller 106, and a developer agitating transporter 125 (a first agitation transport chamber 123 and a second agitation transport chamber 124) provided on the diagonal lower side of the developing roller chamber 122. In the housing 102, a partition wall 103 is formed which separates the first agitation transport chamber 123 and the second agitation transport chamber 124. The housing 102 is provided with an inflow opening (not illustrated) connected to the first agitation transport chamber 123 and the second agitation transport chamber 124 at both ends of the partition wall 103 in the Z direction.

The developing roller 106 has a magnet roller 106A which is formed in a cylindrical shape and fixedly supported by the housing 102 via a shaft (not illustrated), and a cylindrical developing sleeve 106B which is circumferentially movably supported outwardly of the magnet roller 106A. The magnet roller 106A is provided with multiple magnetic poles (not illustrated) in the circumferential direction of the outer circumferential surface. A gear (not illustrated) is fixed at the end of the developing sleeve 106B in the axial direction, a rotational force is transmitted to the gear from a development motor 134, and the developing sleeve 106B is rotated via the gear in the direction of an arrow symbol R1 in FIG. 2.

The first auger 109 includes a rotational shaft 109A disposed in the Z direction, and a spiral transport blade 109B supported on the outer circumference of the rotational shaft 109A. The first auger 109 rotates, for instance, in R2 direction, thereby transporting the developer G while agitating the developer G.

The second auger 111 includes a rotational shaft 111A disposed in the Z direction, and a spiral transport blade 111B supported on the outer circumference of the rotational shaft 111A. The second auger 111 rotates, for instance, in R3 direction, thereby transporting the developer G while agitating the developer G in the opposite direction of the first auger 109.

The developing roller 106 is electrically connected to a development power supply 130 that applies a development voltage across the photoreceptor 22 and the developing roller 106. A superimposed voltage, in which an alternate current component (AC) serving as an alternate current voltage is superimposed on a direct current component (DC) serving as a direct current voltage, is applied from the development power supply 130 to the developing roller 106 as a development voltage. It is to be noted that the waveform of the AC component is a rectangular wave in the exemplary embodiment. However, without being limited to this, the waveform may be a triangular wave or a sine wave. The frequency of the AC component is preferably in a range from 5 kHz or higher to 20 kHz or lower, for instance.

The amplitude value Vpp of the AC voltage is preferably, for instance, from 0.8 kV or higher to 2.2 kHz or lower, more preferably from 1.0 kV or higher to 2.1 kHz or lower, and further preferably from 1.3 kV or higher to 2.0 kHz or lower. In the exemplary embodiment, the amplitude value Vpp of the AC voltage is set to 1.5 kHz.

In the image forming apparatus 10, the development voltage to be applied from the development power supply 130 is set so that the supply rate of the charge of the toner T to a latent image in a solid area of an image of the photoreceptor 22 is 80% or higher. The latent image in a solid area of an image refers to a latent image for which the area coverage of the photoreceptor 22 is 100%. The supply rate of the charge of the toner T to a latent image refers to the neutralization rate for neutralizing the latent image potential with the charge of the toner T, hereinafter may be simply referred to as the “neutralization rate”.

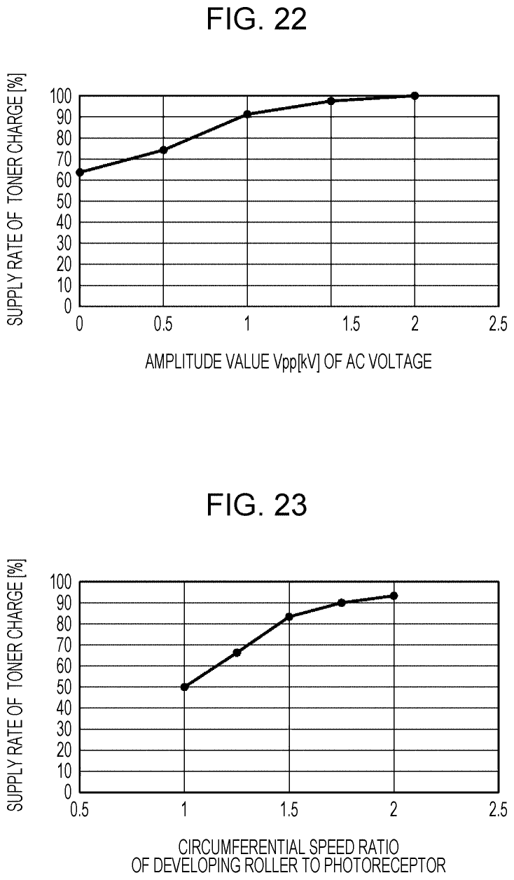

As illustrated in FIG. 22, the supply rate (that is, the neutralization rate) of the charge of the toner T to a latent image is increased as the amplitude value Vpp of the AC voltage of the development voltage is increased. For instance, the supply rate of the charge of the toner T to a latent image in a solid area of an image of the photoreceptor 22 reaches 80% or higher by setting the amplitude value Vpp of the AC voltage to 0.8 kV or higher. The supply rate (that is, the neutralization rate) of the charge of the toner T to a latent image in a solid area of an image of the photoreceptor 22 is preferably 80% or higher, and more preferably 90% or higher. The supply rate of the charge of the toner T will be described in detail later.

A bottom portion of the housing 102 is provided with a permeability sensor 132 that detects the concentration of the toner T (hereinafter referred to as the “toner concentration”) in the developer G. The permeability sensor 132 is a sensor that detects the toner concentration in the developer G by detecting the permeability rate of the developer including non-magnetic toner and magnetic carrier. The permeability sensor 132 is an example of a detector.

Although illustration is omitted, a transport path 144 (see FIG. 1) for replenishing new toner is connected to an upper portion of the housing 102 of the developing device 100.

### <Operation of Developing Device>

Next, the operation of the developing device 100 will be described.

In the developing device 100, the developer G in the first agitation transport chamber 123 and the second agitation transport chamber 124 is transported in opposite directions in the Z direction by the rotation of the first auger 109 and the second auger 111, and thus the developer G is circulated. Then the developer G transported by the first auger 109 is supplied to the developing roller 106.

When the developer G is supplied to the developing roller 106, the developer G is transported by the rotation of the developing sleeve 106B in the R1 direction with the developer G held on the developing sleeve 106B by the multiple magnetic poles of the magnet roller 106A. The developer G held on the developing sleeve 106B enters between the outer circumferential surface of the developing sleeve 106B and the leading end of the layer thickness regulating member 108, the thickness of the layer is thereby regulated, and the developer G is transported to the development area opposed to the photoreceptor 22.

In the development area where the photoreceptor 22 and the developing roller 106 are opposed to each other, application of the development voltage across the photoreceptor 22 and the developing roller 106 from the development power supply 130 causes the toner T of the developer G of the developing sleeve 106B to be transferred to a latent image of the photoreceptor 22. For instance, toner is supplied (in other words, transferred) to a latent image formed on the photoreceptor 22 by a difference potential Vcln between a photoreceptor surface potential Vs and a development voltage Vdev which is a development bias to be applied to the developing roller 106. Consequently, a toner image is formed on the photoreceptor 22.

### <Control System>

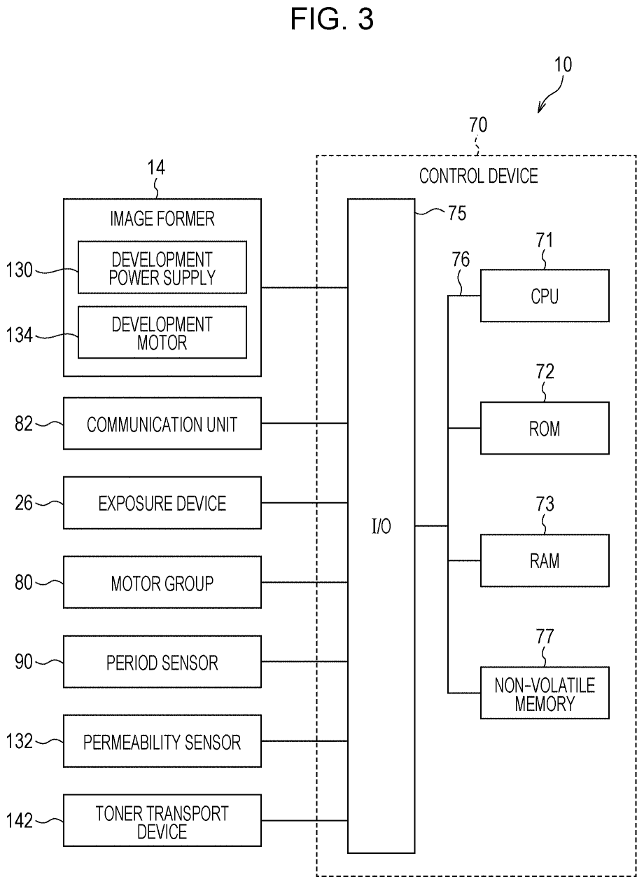

Next, the hardware configuration of the control system of the image forming apparatus 10 will be described with reference to FIG. 3.

As illustrated in FIG. 3, the control device 70 of the image forming apparatus 10 is configurated by a computer, for instance. The control device 70 includes a central processing unit (CPU) 71, a read only memory (ROM) 72, a random access memory (RAM) 73, a non-volatile memory 77, and an input/output interface (I/O) 75. The CPU 71, the ROM 72, the RAM 73, the non-volatile memory 77, and the I/O 75 are coupled to each other via a bus 76.

The CPU 71 is a central processing unit, and executes various programs and controls the components. Specifically, the CPU 71 reads a program from the ROM 72 or the non-volatile memory 77, and executes the program using the RAM 73 as a working area. In the exemplary embodiment, an execution program for executing various types of processing is stored in the non-volatile memory 77.

The ROM 72 stores various programs and various types of data. The RAM 73 serving as a working area temporarily stores programs and/or data. The non-volatile memory 77 is an example of a storage device that maintains the stored information even when power supply is cut off. For instance, a semiconductor memory is used, however, a hard disk may be used.

The toner image former 14, a communication unit 82, the exposing device 26, a motor group 80, the period sensor 90, the permeability sensor 132, and the toner transport device 142 are connected to the I/O 75. The toner image former 14 includes the development power supply 130 for applying a development voltage, and the development motor 134 that circumferentially moves the developing sleeve 106B. The motor group 80 includes motors for driving various rollers of a transport system.

The control device 70 adjusts the potential difference between the photoreceptor 22 and the developing roller 106 by controlling the development bias to be applied from the development power supply 130 or the exposure amount of light from the exposing device 26 to the photoreceptor 22 based on the periodic information detected by the period sensor 90. Thus, the development amount of the toner T to the photoreceptor 22 is corrected to perform concentration correction. In the concentration correction, the development bias to be applied from the development power supply 130 or the exposure amount of light from the exposing device 26 to the photoreceptor 22 is controlled with reference to an output concentration profile with a constant area coverage. In the exemplary embodiment, the correction amount to the development bias or the exposure amount varies depending on the difference in the area coverage. In the exemplary embodiment, correction is made with the average value of the area coverage 20% and the area coverage 80%. The control device 70 is an example of a corrector.

The image forming apparatus 10 controls the concentration difference in the output image of the photoreceptor 22 in the axial direction with the area ratio of exposure patterns in the output patterns formed from one developing device 100. In other words, control of the concentration difference in the output image in the axial direction is achieved by changing the area coverage. In the development power supply 130, a development voltage which is constant in the axial direction of the developing roller 106 is set to be applied.

### <Operations and Effects>

Next, the operations and effects of the exemplary embodiment will be described. First, an image forming apparatus of a comparative example will be described before a description of the operations and effects of the exemplary embodiment is given.

In the image forming apparatus of a comparative example, the amplitude value Vpp of the AC voltage of the development voltage applied from the development power supply is set to 0.6 kV. The circumferential speeds of the developing roller and the photoreceptor are set equal in the area where the developing roller and the photoreceptor are opposed to each other.

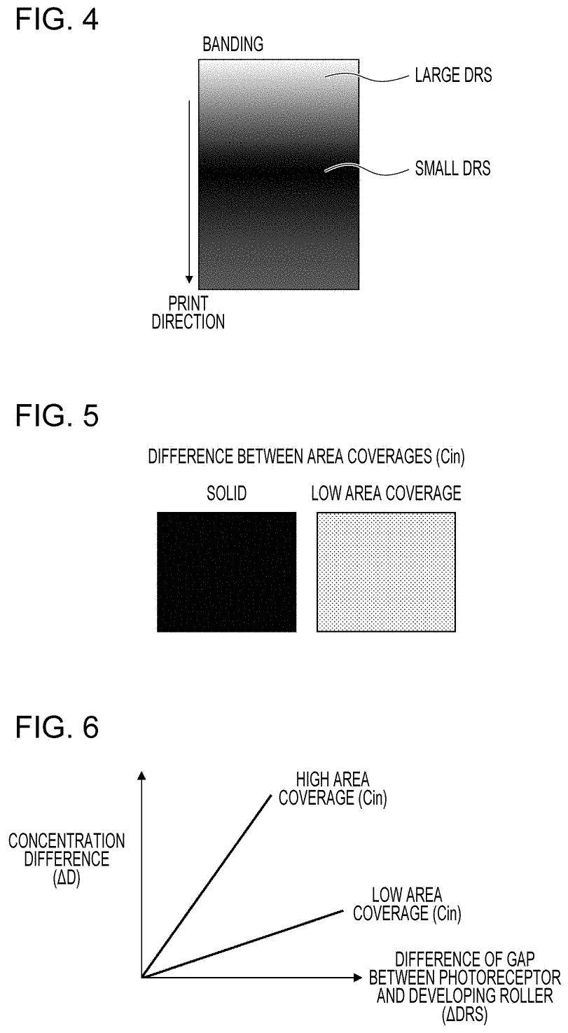

In general in an image forming apparatus, as illustrated in FIG. 4, the gap (DRS) between the developing roller and the photoreceptor changes periodically due to oscillation and eccentricity of the developing roller and the photoreceptor, and periodic concentration unevenness (so-called banding) occurs at positions where the gap is large or small in the print direction (that is, the circumferential direction). Since the development electric field depends on the distance between the developing roller and the photoreceptor, when the distance between the developing roller and the photoreceptor is changed, the development amount of toner is changed. Therefore, when the gap between the developing roller and the photoreceptor is large, the concentration of an image is decreased, and when the gap between the developing roller and the photoreceptor is small, the concentration of an image is increased.

In the image forming apparatus of a comparative example, periodic information due to periodic change in the gap between the developing roller and the photoreceptor is detected by a period sensor, and the exposure amount (specifically, the potential difference between the developing member and the image carrier) to the photoreceptor of the exposing device is controlled based on the periodic information. Thus, the development amount of toner is corrected.

However, in the periodic concentration unevenness (so-called banding), the concentration difference (ΔD) between a high concentration area and a low concentration area varies depending on the area coverage (Cin). FIG. 5 illustrates a sold image with the area coverage of 100% and an image with a low area coverage. As illustrated in FIG. 6, as the difference (ΔDRS) in the gap between the photoreceptor and the developing roller is increased, the concentration difference (ΔD) is increased for a higher area coverage.

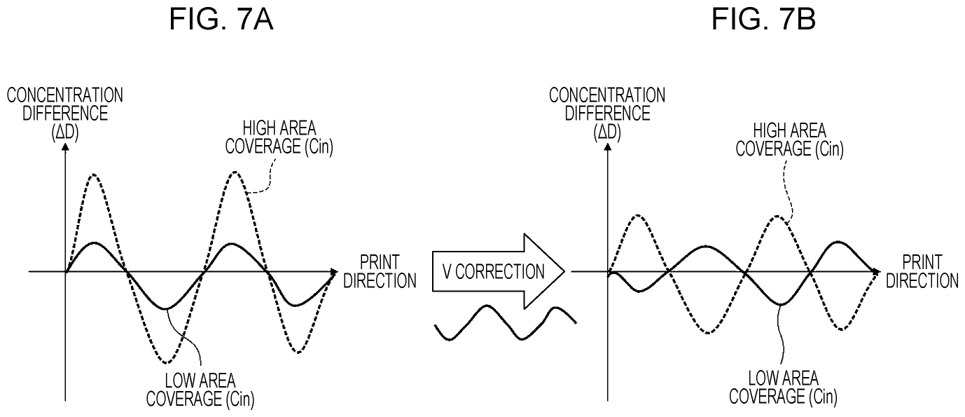

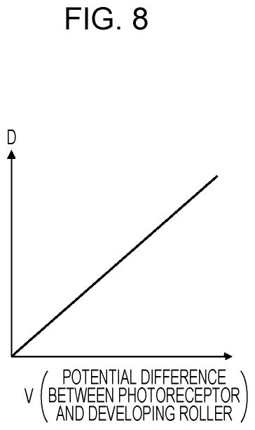

Thus, as illustrated in FIGS. 7A and 7B, when a correction amount is controlled with an exposure amount (the potential difference between the developing roller and the photoreceptor is corrected) which is constant in the axial direction of the photoreceptor, the effectiveness of concentration correction is different for each area coverage because the concentration difference varies depending on the area coverage. As illustrated in FIG. 7B, particularly when the area coverage is high, correction is insufficient, and the concentration difference (ΔD) is likely to be increased. It is to be noted that in the image forming apparatus of the comparative example, the potential difference V between the developing roller and the photoreceptor is constant in the axial direction of the photoreceptor, and control of the concentration difference in the output image of the photoreceptor in the axial direction is achieved by changing the area coverage. FIG. 8 illustrates the relationship between the potential difference V across the photoreceptor and the developing roller, and the concentration D.

In the image forming apparatus of the comparative example, correction is made with the average value of the area coverage 20% and the area coverage 80%. In this case, the area coverages incudes one for which correction to the development amount of toner is excessively effective and the other one for which correction to the development amount of toner is insufficient. When excessive correction and insufficient correction coexist, the concentration difference (ΔD) is increased, and the correction may cause unintentional deterioration of the printing quality.

For instance, a method may be adopted in which an area coverage is assumed from the output image patterns, and the exposure amount is adjusted at positions of the photoreceptor in the axial direction. However, increased complexity and increased cost of the image forming apparatus, such as an increase in the capacity of the calculation memory, is inevitable.

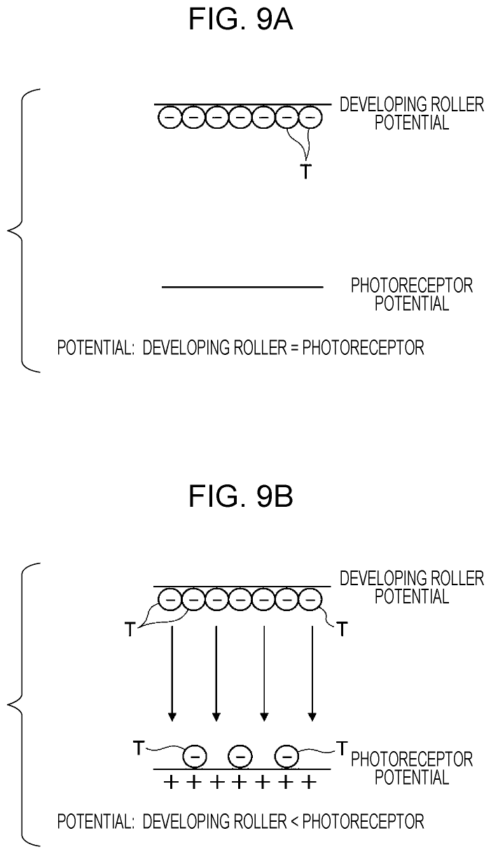

The causes why the concentration difference (ΔD) for the variation in the gap between the photoreceptor and the developing roller is different depending on the area coverage include a difference in the supply rate (that is, the neutralization rate) of the charge of toner to a latent image. The supply rate of the charge of toner indicating an occupancy rate of charge to a latent image is changed by movement of the toner in the development nip. As illustrated in FIG. 9A, when there is no potential difference between the developing roller and the photoreceptor, the toner T with a negative polarity of the developing roller is not moved to the photoreceptor. As illustrated in FIG. 9B, when there is a potential difference between the developing roller and the photoreceptor (for instance, the potential of the developing roller<the potential of the photoreceptor), the toner T of the developing roller is moved to a portion (specifically, the latent image in an exposure portion) with a positive potential of the photoreceptor.

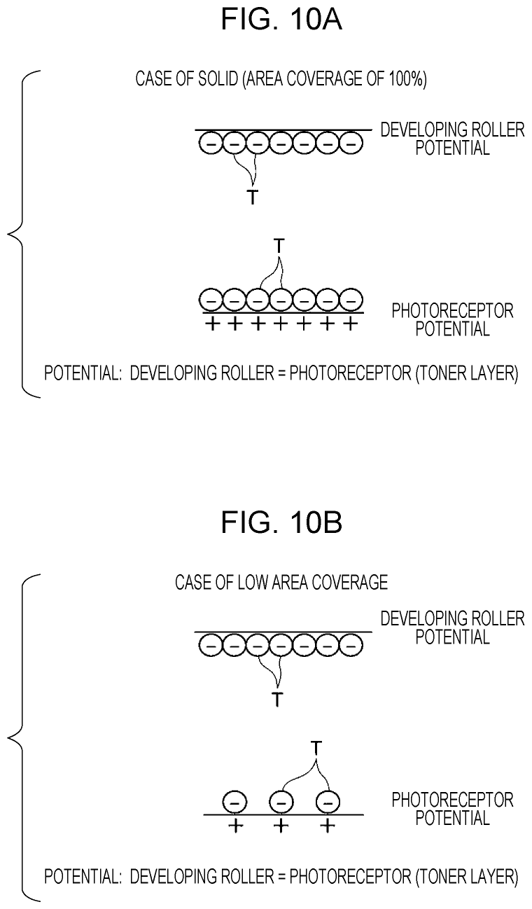

As illustrated in FIG. 10A, when the potentials of toner layers adhering to the surfaces of the developing roller and the photoreceptor become equal (in other words, when the potential difference disappears), the development process is stopped. This state is defined as the toner T supply restricted state, in other words, the state where the supply rate (that is, the neutralization rate) of the charge of toner to a latent image reaches 100%. In this case, even when the gap between the photoreceptor and the developing roller is changed, no potential difference occurs between the developing roller and the photoreceptor (that is, a toner layer adhering to the photoreceptor), and a force for supplying toner is not applied. Therefore, when the supply rate of the charge of toner to a latent image is high, the effect of the variation in the gap between the photoreceptor and the developing roller on the concentration difference (ΔD) is low.

In contrast, as illustrated in FIGS. 10A and 10B, when a latent image is formed with the same exposure amount in the case of different area coverages (that is, when the potential differences between the developing roller and the photoreceptor are the same), a necessary charge amount per unit area varies. As illustrated in FIG. 10B, when the area coverage is low, a necessary charge amount per unit area is reduced. Conversely, as illustrated in FIG. 10A, when the area coverage is high, a greater supply of charge amount per unit area is necessary. In other words, when the area coverage is low, the amount of the toner T necessary for the photoreceptor is reduced as compared with the case of a solid image (that is, the area coverage is 100%).

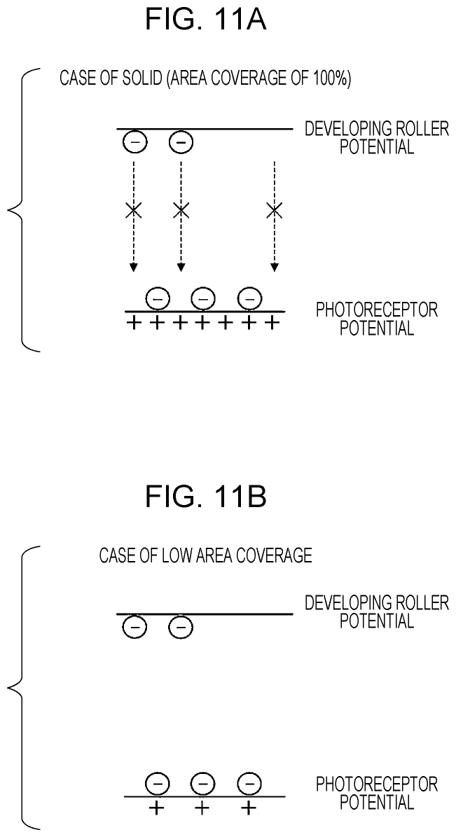

Therefore, when the area coverage is low, the supply rate (that is, the neutralization rate) of the charge of the toner T is likely to be increased (see FIG. 11B), and when the area coverage is high, the supply rate of the charge of the toner T is likely to be decreased (see FIG. 11A). Therefore, a high or low supply rate of the charge of toner for each area coverage causes the concentration difference (ΔD) for the variation in the gap between the photoreceptor and the developing roller.

For instance, when the development electric field to cause the toner to fly in the development nip is low, or when the amount of toner is small, the toner supply performance is low, and it is not possible to increase the supply rate (that is, the neutralization rate) of the charge of toner. In this case, as illustrated in FIG. 11B, when the area coverage is low, the amount of the toner T necessary for the photoreceptor is small, the toner T supply restricted state is likely to be achieved, and the supply rate of the charge of toner is increased. When the toner supply restricted state is achieved, the dependency of the development electric field is almost lost, and the toner is unlikely to be flown. Therefore, concentration change for the variation in the gap between the photoreceptor and the developing roller is unlikely to occur (see FIG. 6).

However, as illustrated in FIG. 11A, when the area coverage is high, the amount of the toner T necessary for the photoreceptor is large, the toner T supply restricted state is unlikely to be achieved, and the supply rate (that is, the neutralization rate) of the charge of the toner T is decreased. When the toner supply restricted state is not achieved, the toner is likely to be flown at positions where the gap (DRS) between the photoreceptor and the developing roller is small, and the toner is unlikely to be flown at positions where the gap (DRS) between the photoreceptor and the developing roller is large. Therefore, concentration change for the variation in the gap between the photoreceptor and the developing roller is likely to occur (see FIG. 6).

In the image forming apparatus 10 in the exemplary embodiment, for a latent image potential of the photoreceptor 22 forming a solid area of an image, the toner T is more effectively developed during nip passage in the developing device 100 than in the image forming apparatus of the comparative example, thus the potential of the photoreceptor 22 is made closer to the potential of the developing roller 106, and the photoreceptor 22 is set to the toner T supply restricted state.

More specifically, in the image forming apparatus 10, the amplitude value Vpp of the AC voltage of the development voltage to be applied from the development power supply 130 is set to 0.8 kV or higher (1.5 kV in the exemplary embodiment). Thus, flying performance of the toner T from the developing roller 106 to the photoreceptor 22 is enhanced, and the toner supply performance is thereby increased and even with a high area coverage, the supply rate (that is, the neutralization rate) of the charge of the toner T is increased. As illustrated in FIG. 22, in the image forming apparatus 10, the amplitude value Vpp of the AC voltage of the development voltage is set to 1.5 kV, and thus the supply rate (that is, the neutralization rate) of the charge of the toner T reaches 97% or higher. Consequently, for all area coverages, the supply rate of the charge of toner is maintained at a high level, and an image with a stable concentration for the variation in the gap between the photoreceptor 22 and the developing roller 106 is outputted.

The supply rate (that is, the neutralization rate in a solid area) of the charge of toner in a solid area is calculated by the following expression:

neutralization rate in a solid area=(toner layer potential after passing nip−latent image potential)/(potential of developing roller−latent image potential)×100 [%]

In the exemplary embodiment, the supply rate of the charge of toner in a solid area is set to a percentage of higher, the percentage being the area coverage of a profile referenced as a standard of concentration correction.

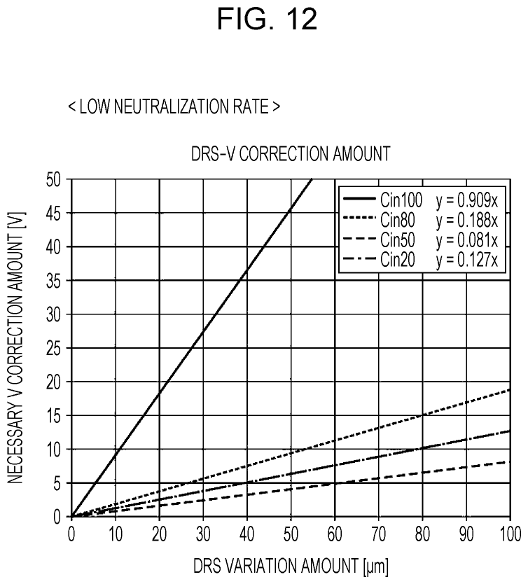

FIG. 12 illustrates the relationship between the variation amount in the gap (DRS) across the photoreceptor and the developing roller according to a difference in the area coverage (Cin), and a necessary correction amount to the potential difference (V) between the photoreceptor and the developing roller in the image forming apparatus of the comparative example. The variation amount in the gap (DRS) between the photoreceptor and the developing roller has the same meaning as the difference (ΔDRS) in the gap between the photoreceptor and the developing roller. In the image forming apparatus of the comparative example, as described above, the amplitude value Vpp of the AC voltage of the development voltage to be applied from development power supply is set to 0.6 kV, and the supply rate (that is, the neutralization rate) of the charge of the toner T is low. As illustrated in FIG. 12, in the image forming apparatus of the comparative example, in the case of a solid area (the area coverage 100%), as the variation amount in the gap (DRS) between the photoreceptor and the developing roller is increased, a necessary correction amount to the potential difference (V) between the photoreceptor and the developing roller is increased.

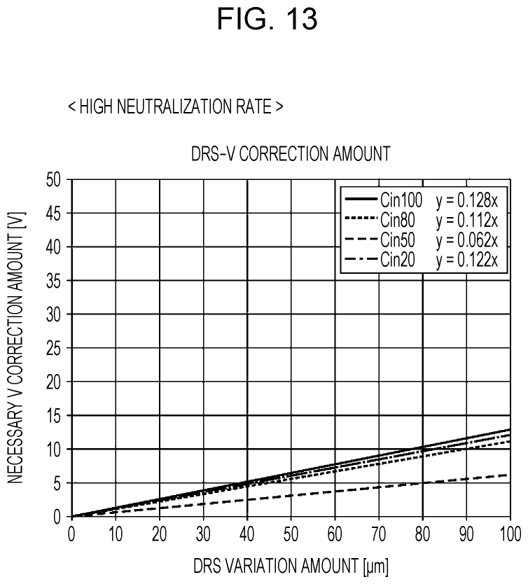

FIG. 13 illustrates the relationship between the variation amount in the gap (DRS) across the photoreceptor 22 and the developing roller 106 according to a difference in the area coverage (Cin), and a necessary correction amount to the potential difference (V) between the photoreceptor 22 and the developing roller 106 in the image forming apparatus 10 in the exemplary embodiment. In the image forming apparatus 10, the amplitude value Vpp of the AC voltage of the development voltage to be applied from the development power supply 130 is set to 1.5 kV, and the supply rate (that is, the neutralization rate) of the charge of the toner T is high (see FIG. 22). As illustrated in FIG. 13, in the image forming apparatus 10, in the case of a solid area (the area coverage 100%), a necessary correction amount to the potential difference (V) between the photoreceptor 22 and the developing roller 106 for the variation amount in the gap (DRS) between the photoreceptor 22 and the developing roller 106 is lower than in the image forming apparatus of the comparative example.

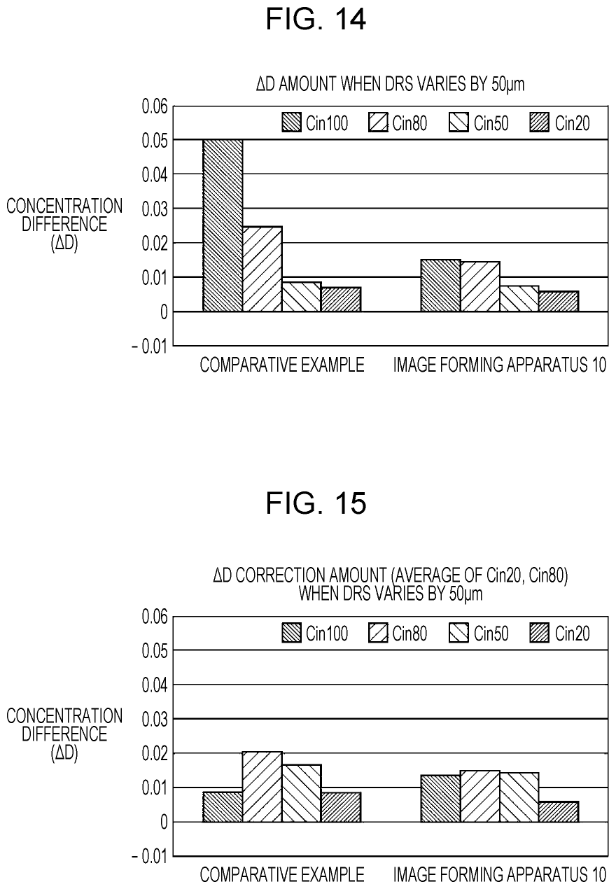

FIG. 14 illustrates the concentration difference (ΔD) according to a difference in the area coverage (Cin) when the gap (DRS) between the photoreceptor 22 and the developing roller 106 varies by 50 μm in the image forming apparatus of the comparative example and in the image forming apparatus 10 in the exemplary embodiment. As illustrated in FIG. 14, in the image forming apparatus 10 in the exemplary embodiment, the concentration difference (ΔD) with the area coverage 100% is smaller than in the image forming apparatus of the comparative example.

FIG. 15 illustrates the correction amount to the concentration difference (ΔD) according to a difference in the area coverage (Cin) when the gap (DRS) between the photoreceptor 22 and the developing roller 106 varies by 50 μm in the image forming apparatus of the comparative example and in the image forming apparatus 10 in the exemplary embodiment. In FIG. 15, the concentration difference (ΔD) is corrected with the average of the area coverages 20% and 80%.

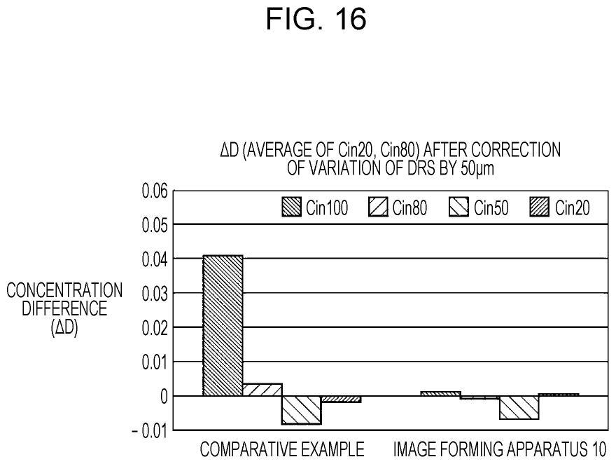

FIG. 16 illustrates the concentration difference (ΔD) after correction according to a difference in the area coverage (Cin) when the gap (DRS) between the photoreceptor 22 and the developing roller 106 varies by 50 μm in the image forming apparatus of the comparative example and in the image forming apparatus 10 in the exemplary embodiment. In FIG. 16, the concentration difference (ΔD) after correction is obtained by subtracting the correction amount to the concentration difference (ΔD) illustrated in FIG. 15 from the concentration difference (ΔD) illustrated in FIG. 14. As illustrated in FIG. 16, in the image forming apparatus 10 in the exemplary embodiment, the concentration difference (ΔD) for all area coverages including the area coverage of 100% is smaller than in the image forming apparatus of the comparative example. Particularly, in the image forming apparatus 10 in the exemplary embodiment, the concentration difference (ΔD) for the area coverage of 100% is smaller than in the image forming apparatus of the comparative example.

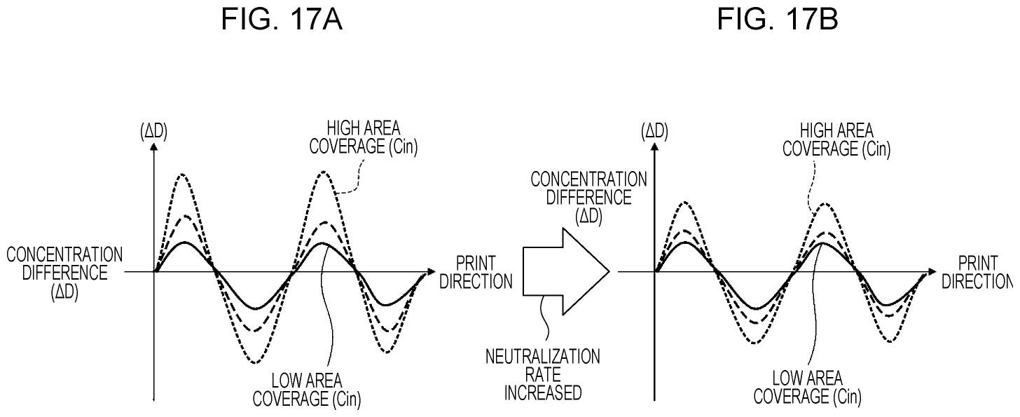

FIG. 17A illustrates the concentration difference (ΔD) according to a difference in the area coverage in the print direction. FIG. 17B illustrates the concentration difference (ΔD) according to a difference in the area coverage in the print direction when the supply rate (that is, the neutralization rate) of the charge of the toner T is increased. As illustrated in FIG. 17B, the concentration difference (ΔD) according to a difference in the area coverage in the print direction is reduced by increasing the supply rate of the charge of the toner T.

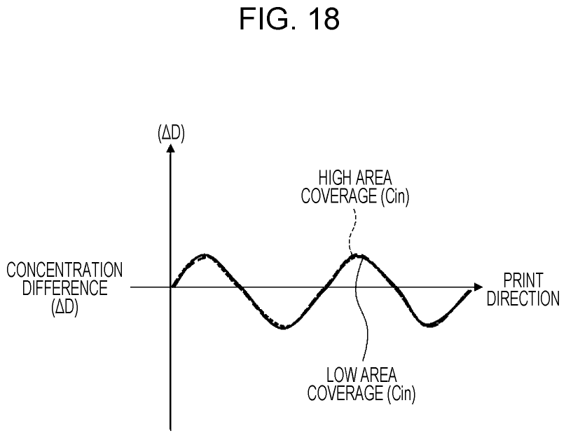

FIG. 18 illustrates the concentration difference (ΔD) according to a difference in the area coverage in the print direction when the supply rate (that is, the neutralization rate) of the charge of the toner T in a solid area is 100%. As illustrated in FIG. 18, the concentration difference (ΔD) according to a difference in the area coverage disappears when the supply rate of the charge of the toner T is 100% in a solid area with the area coverage 100%.

In the image forming apparatus 10 in the exemplary embodiment, the development power supply 130 is set so that the supply rate of the charge of the toner T to a latent image in a solid area of an image reaches 80% or higher. Thus, in the image forming apparatus 10, the image concentration unevenness which occurs in the axial direction of the photoreceptor 22 is reduced as compared with when the supply rate of the charge of the toner to a latent image in a solid area of an image is lower than 80%.

In addition, in the image forming apparatus 10 in the exemplary embodiment, the development voltage to be applied from the development power supply 130 is a superimposed voltage in which an AC voltage is superimposed on a DC voltage, and the amplitude value Vpp of the AC voltage is set to 0.8 kV or higher and 2.2 kHz or lower. Thus, in the image forming apparatus 10, the image concentration unevenness which occurs in the axial direction of the image carrier is reduced as compared with when the amplitude value Vpp of the AC voltage is lower than 0.8 kV. In addition, the consumption energy is smaller as compared with when the amplitude value Vpp of the AC voltage is higher than 2.2 kV.

### Exemplary Embodiment

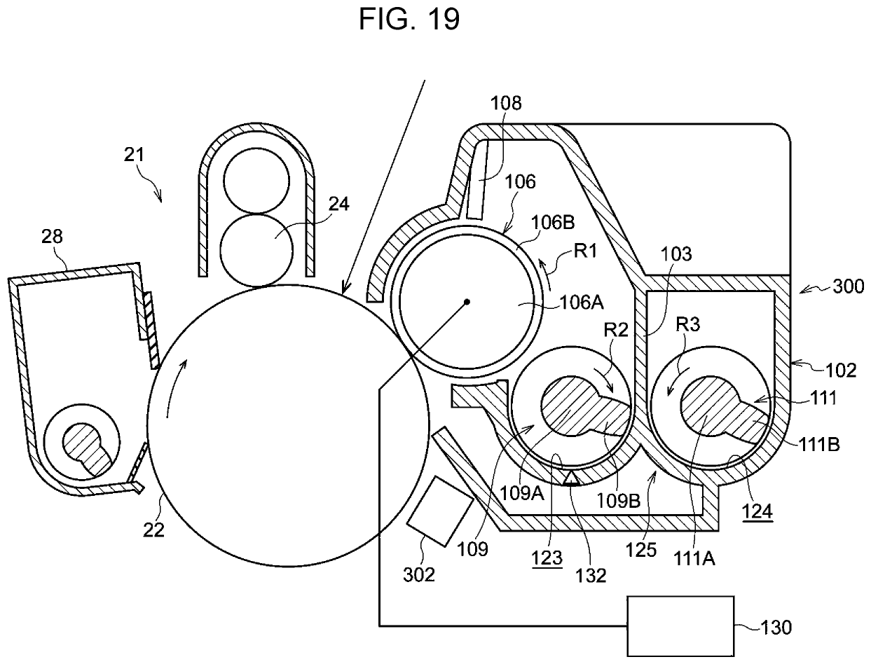

The supply rate (that is, the neutralization rate) of the charge of the toner T is controlled at 75, 80, 90, 100% by substituting the amplitude value Vpp of the AC voltage of the development voltage with one of the range of 0.4, 0.6, 1.0, 1.2 kV by using an image forming apparatus 300 illustrated in FIG. 19. The supply rate (that is, the neutralization rate) of the charge of the toner T is fixed, and an image with full halftone (the area coverages 20, 50, 80, 100%) is outputted.

The gap (DRS) between the photoreceptor 22 and the developing roller 106 is set to 230 μm and 330 μm, and the concentration is measured. Let ΔD be the concentration difference, and data is obtained. Furthermore, the image quality is evaluated from an image with halftone.

As illustrated in FIG. 19, in the image forming apparatus 300, a potential sensor 302 for the photoreceptor 22 is disposed on the downstream side of the developing roller 106 in the rotational direction of the photoreceptor 22 within the developing device 100. The potentials with toner developed on the photoreceptor 22 and with no toner developed on the photoreceptor are measured by the potential sensor 302, and the supply rate (that is, the neutralization rate) of the charge of the toner T is calculated. The potential with no toner developed is measured with no developing roller provided.

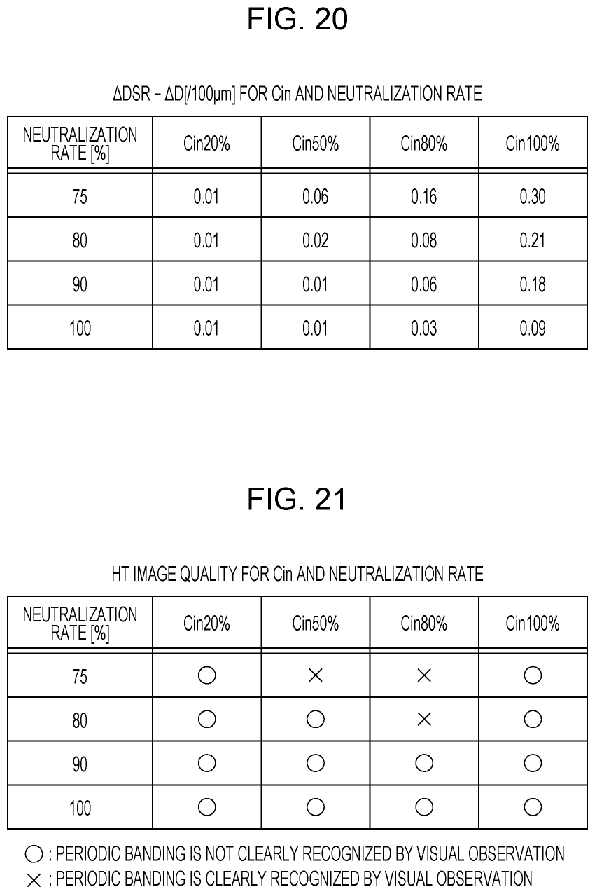

FIG. 20 is a table illustrating the value obtained by subtracting the concentration difference (ΔD) from the difference (ΔDRS) in the gap between the photoreceptor 22 and the developing roller 106 for each area coverage and each supply rate (that is, the neutralization rate) of the charge of the toner T.

FIG. 21 is a table illustrating the evaluation of quality of an image with halftone for each area coverage and each supply rate (that is, the neutralization rate) of the charge of the toner T. Here, “◯” indicates a level in which periodic banding is not clearly recognized by visual observation, and “x” indicates a level in which periodic banding is clearly recognized by visual observation. Numeric values do not correspond to each other between the table illustrated in FIG. 20 and the table illustrated in FIG. 21. This is because the absolute value of concentration varies depending on an image with halftone, and thus a difference in the visibility occurs and halftone is easily visible. As illustrated in FIG. 21, it is verified that periodic banding of concentration is not recognized in an image with halftone in a solid area with the area coverage 100% by setting the supply rate (that is, the neutralization rate) of the charge of the toner T to 80% or higher.

### Second Exemplary Embodiment

Next, an image forming apparatus according a second exemplary embodiment will be described. It is to be noted that the same component as in the first exemplary embodiment described above is labeled with the same number and a description thereof is omitted.

In the image forming apparatus 10 in the first exemplary embodiment, the amplitude value Vpp of the AC voltage of the development voltage to be applied from the development power supply 130 is set high. However, instead of this, in the image forming apparatus 10 in the second exemplary embodiment, the circumferential speed of the developing roller 106 is set higher than the circumferential speed of the photoreceptor 22 in the area where the photoreceptor 22 and the developing roller 106 are opposed to each other. In the second exemplary embodiment, as an example, the circumferential speed of the developing roller 106 is set to 1.8 times the circumferential speed of the photoreceptor 22 in the area where the photoreceptor 22 and the developing roller 106 are opposed to each other. In other words, the circumferential speed ratio of the developing roller 106 to the photoreceptor 22 is set to 1.8. In the image forming apparatus 10 in the second exemplary embodiment, the rotational force from the development motor 134 is transmitted to the developing sleeve 106B of the developing roller 106, and thus the developing sleeve 106B is circumferentially moved.

In the image forming apparatus 10 in the second exemplary embodiment, the amplitude value Vpp of the AC voltage of the development voltage to be applied from the development power supply 130 is set to 0.6 kV.

In FIG. 23, the relationship between the circumferential speed ratio of the developing roller to the photoreceptor and the supply rate of toner charge is illustrated by a graph. As illustrated in FIG. 23, as the circumferential speed ratio of the developing roller to the photoreceptor is increased, the supply rate (that is, the neutralization rate) of the charge of the toner T to a latent image is enhanced. For instance, the supply rate (that is, the neutralization rate) of the charge of the toner T to a latent image in a solid area of an image of the photoreceptor 22 reaches 80% or higher by setting the circumferential speed ratio of the developing roller to the photoreceptor to 1.4 or higher.

In the area where the photoreceptor 22 and the developing roller 106 are opposed to each other, the ratio of the circumferential speed of the developing roller 106 to the circumferential speed of the photoreceptor 22 is preferably in a range from 1.4 to 2.5, more preferably in a range from 1.5 to 2.2, and further preferably in a range from 1.7 to 2.0.

In the image forming apparatus 10 in the second exemplary embodiment, the developing device 100 is set so that the supply rate of the charge of the toner T to a latent image in a solid area of an image reaches 80% or higher. Thus, in the image forming apparatus 10, the image concentration unevenness which occurs in the axial direction of the photoreceptor 22 is reduced as compared with when the supply rate of the charge of the toner to a latent image in a solid area of an image is lower than 80%.

In the image forming apparatus 10 in the second exemplary embodiment, the circumferential speed of the developing roller 106 is set faster than the circumferential speed of the photoreceptor 22 in the area where the photoreceptor 22 and the developing roller 106 are opposed to each other. Thus, the image concentration unevenness which occurs in the axial direction of the photoreceptor 22 is reduced as compared with when the circumferential speed of the developing member and the circumferential speed of the image carrier are the same in the area where the image carrier and the developing member are opposed to each other.

In the image forming apparatus 10 in the second exemplary embodiment, the ratio of the circumferential speed of the developing roller 106 to the circumferential speed of the photoreceptor 22 is in a range from 1.4 to 2.5 in the area where the photoreceptor 22 and the developing roller 106 are opposed to each other. Thus, the image concentration unevenness which occurs in the axial direction of the photoreceptor 22 is reduced as compared with when the ratio of the circumferential speed of the developing member to the circumferential speed of the image carrier is lower than 1.4. In addition, scattering of the toner T from the development area occurs less, as compared with when the ratio of the circumferential speed of the developing member to the circumferential speed of the image carrier is higher than 2.5.

### Third Exemplary Embodiment

Next, an image forming apparatus according a third exemplary embodiment will be described. It is to be noted that the same component as in the first exemplary embodiment described above is labeled with the same number and a description thereof is omitted.

In the image forming apparatus 10 in the first exemplary embodiment, the amplitude value Vpp of the AC voltage of the development voltage to be applied from the development power supply 130 is set high. However, instead of this, in the image forming apparatus 10 in the third exemplary embodiment, the toner concentration in the developer G within the developing device 100 is increased. In the image forming apparatus 10 in the third exemplary embodiment, the toner concentration in the developer G within the developing device 100 in a normal state is set higher than the toner concentration in the developer within the developing device of the image forming apparatus of the comparative example.

In the image forming apparatus 10 in the third exemplary embodiment, as illustrated in FIG. 3, the toner concentration in the developer G within the developing device 100 is detected by the permeability sensor 132, and when a value detected by the permeability sensor 132 is lower than a threshold, a transport member (not illustrated) within the toner transport device 142 is driven to increase the amount of the toner in the developer G. For instance, when an image in a solid area is developed more often, the toner concentration in the developer G detected by the permeability sensor 132 is reduced, thus toner is replenished into the developing device 100 by the toner transport device 142 to increase the amount of the toner in the developer G. Thus, the amount of the toner T in the development area is increased due to the increased toner concentration in the developer G within the developing device 100, and the supply rate of the charge of the toner T to a latent image in a solid area of an image is increased. In the exemplary embodiment, the toner concentration in the developer G within the developing device 100 is controlled so that the supply rate of the charge of the toner T to a latent image in a solid area of an image reaches 80% or higher.

In the image forming apparatus 10 in the third exemplary embodiment, the developing device 100 is set so that the supply rate of the charge of the toner T to a latent image in a solid area of an image reaches 80% or higher. Thus, in the image forming apparatus 10, the image concentration unevenness which occurs in the axial direction of the photoreceptor 22 is reduced as compared with when the supply rate of the charge of the toner to a latent image in a solid area of an image is lower than 80%.

It is to be noted that a configuration may be adopted in which any two or more settings between the setting of the development power supply 130 and the setting of the developing device 100 in the image forming apparatus in the first to third exemplary embodiments may be combined. In this manner, the supply rate of the charge of the toner T to a latent image in a solid area of an image is likely to be set 80% or higher, as compared with when only one setting is used.

The configuration of each member in the image forming apparatus in the first to third exemplary embodiments may be modified.

Although specific exemplary embodiments of the disclosure have been described in detail, the disclosure is not limited to those exemplary embodiments, and it is apparent to those skilled in the art that other various exemplary embodiments may be implemented within the scope of the disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
an image carrier in which a latent image is formed;
a developing device that transfers toner to the latent image from a developing member opposed to the image carrier, and develops the latent image;
a development power supply that applies a development voltage across the image carrier and the developing member;
a period detector that detects periodic information on the developing member and the image carrier in a circumferential direction; and
a corrector that corrects the development voltage or an exposure amount of the latent image based on the periodic information detected by the period detector,
wherein at least one of the developing device and the development power supply is set so that a supply rate of charge of the toner to the latent image in a solid area of an image reaches 80% or higher.

2. The image forming apparatus according to claim 1,
wherein at least one of the developing device and the development power supply is set so that the supply rate of the charge of the toner to the latent image in the solid area reaches 90% or higher.

3. The image forming apparatus according to claim 1,
wherein the development voltage is a superimposed voltage in which an AC voltage is superimposed on a DC voltage, and
an amplitude value Vpp of the AC voltage is set to 0.8 kV or higher and 2.2 kV or lower.

4. The image forming apparatus according to claim 2,
wherein the development voltage is a superimposed voltage in which an AC voltage is superimposed on a DC voltage, and
an amplitude value Vpp of the AC voltage is set to 0.8 kV or higher and 2.2 kV or lower.

5. The image forming apparatus according to claim 3,
wherein the amplitude value Vpp of the AC voltage is set to 1.0 kV or higher and 2.1 kV or lower.

6. The image forming apparatus according to claim 4,
wherein the amplitude value Vpp of the AC voltage is set to 1.0 kV or higher and 2.1 kV or lower.

7. The image forming apparatus according to claim 1, further comprising
a detector that detects a toner concentration in developer within the developing device,
wherein an amount of toner in the developer is increased according to the toner concentration detected by the detector.

8. The image forming apparatus according to claim 2, further comprising
a detector that detects a toner concentration in developer within the developing device,
wherein an amount of toner in the developer is increased according to the toner concentration detected by the detector.

9. The image forming apparatus according to claim 3, further comprising
a detector that detects a toner concentration in developer within the developing device,
wherein an amount of toner in the developer is increased according to the toner concentration detected by the detector.

10. The image forming apparatus according to claim 4, further comprising
a detector that detects a toner concentration in developer within the developing device,
wherein an amount of toner in the developer is increased according to the toner concentration detected by the detector.

11. The image forming apparatus according to claim 5, further comprising
a detector that detects a toner concentration in developer within the developing device,
wherein an amount of toner in the developer is increased according to the toner concentration detected by the detector.

12. The image forming apparatus according to claim 6, further comprising
a detector that detects a toner concentration in developer within the developing device,
wherein an amount of toner in the developer is increased according to the toner concentration detected by the detector.

13. The image forming apparatus according to claim 1,
wherein a circumferential speed of the developing member is set faster than a circumferential speed of the image carrier in an area where the image carrier and the developing member are opposed to each other.

14. The image forming apparatus according to claim 2,
wherein a circumferential speed of the developing member is set faster than a circumferential speed of the image carrier in an area where the image carrier and the developing member are opposed to each other.

15. The image forming apparatus according to claim 3,
wherein a circumferential speed of the developing member is set faster than a circumferential speed of the image carrier in an area where the image carrier and the developing member are opposed to each other.

16. The image forming apparatus according to claim 4,
wherein a circumferential speed of the developing member is set faster than a circumferential speed of the image carrier in an area where the image carrier and the developing member are opposed to each other.

17. The image forming apparatus according to claim 5,
wherein a circumferential speed of the developing member is set faster than a circumferential speed of the image carrier in an area where the image carrier and the developing member are opposed to each other.

18. The image forming apparatus according to claim 6,
wherein a circumferential speed of the developing member is set faster than a circumferential speed of the image carrier in an area where the image carrier and the developing member are opposed to each other.

19. The image forming apparatus according to claim 7,
wherein a circumferential speed of the developing member is set faster than a circumferential speed of the image carrier in an area where the image carrier and the developing member are opposed to each other.

20. The image forming apparatus according to claim 13,
wherein a ratio of the circumferential speed of the developing member to the circumferential speed of the image carrier is in a range from 1.4 to 2.5 in the area where the image carrier and the developing member are opposed to each other.
